(19) United States
(12) Patent Application Publication
(10) Pub. No.: US 2004/0197105 A1
(43) Pub. Date: Oct. 7, 2004

(54) Variable gain multi-stage optical amplifier

(75) Inventors: Sunil Khatana, Sunnyvale, CA (US); William S. Wong, Ann Arbor, MI (US); George Zarris, Sidcup (GB); Frank Shum, Sunnyvale, CA (US); Mark Bray, Boreham (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS UNIPHASE CORPORATION, San Jose, CA

(21) Appl. No.: 10/778,262

(22) Filed: Feb. 13, 2004

Related U.S. Application Data
(60) Provisional application No. 60/447,781, filed on Feb. 14, 2003.

(51) Int. Cl. H04B 10/02

(52) U.S. Cl. 398/173

(57) ABSTRACT

A multistage optical amplifier is disclosed with programmable gain for operation in an automatic gain control mode that has a low noise figure or an optimal or near optimal noise figure. The programmable-gain optical amplifier has several amplifying stages separated by variable optical attenuators (VOAs) and may have mid-stage access devices (MSA) such as dispersion compensating fiber or optical add/drop modules. A method of selecting attenuation values for the VOAs for realizing low noise figure for various values of the overall optical gain is also disclosed. The loss among the amplifier stages is distributed and predetermined attenuation values for the VOAs are selected so as to minimize the overall noise figure of the multistage amplifier. The predetermined attenuation levels are determined during the amplifier calibration process taking into consideration the pump power limits, nonlinearity limits in the dispersion compensating fiber and the required overall optical amplifier gain.

### CROSS-REFERENCE TO RELATED APPLICATIONS

This application claims priority from U.S. provisional application No. 60/447,781 filed Feb. 14, 2003.

### MICROFICHE APPENDIX

Not Applicable

### TECHNICAL FIELD

The present application relates to a multi-stage optical fiber amplifier for operation in a gain control regime having a programmable overall-optical gain and a low noise figure.

### BACKGROUND OF THE INVENTION

Optical networks increasingly use wavelength division multiplexing (WDM) as a method to increase bandwidth. Multiple optical channels are combined and transmitted simultaneously as a single multiplexed signal. At the receiving end a demultiplexer separates the channels by wavelength and routes individual channels.

Optical amplifiers are commonly used in optical communication systems as in-line amplifiers for boosting signal levels to compensate for losses in a transmission link, and to increase an signal to noise ratio (SNR) at a receiver. In WDM systems, optical amplifiers based on doped optical fibers are particularly useful because of their ability to amplify many optical channels simultaneously. Rare earth doped fiber optical amplifiers, such as erbium doped fiber amplifiers (EDFA) are used extensively. In addition other dopants can also be used to absorb pump energy to cause a population inversion and thus provide amplification. An example of a transmission link with in-line optical amplifiers is shown in FIG. 1.

In legacy point-to-point optical systems where total number of optical channels does not change during normal operation, optical amplifiers may normally operate in an automatic power control (APC) mode, also referred to as an automatic level control (ALC) mode, designed to maintain constant total output power from the amplifier when its input power fluctuates. This is achieved by monitoring total optical power at the output of the amplifier and dynamically adjusting the amplifier's pump power to vary its optical gain in counter-phase with fluctuations of the incoming signal power.

For a fault-free signal transmission however it is the power per channel that has to be maintained rather than a total optical power of the WDM signal. In operation of an optical network, channels can be periodically added or dropped for switching and routing, causing significant changes to an input power into the amplifiers. The number of channels, and hence the total optical power of a signal may also vary due to network reconfigurations, failures or recovery from failures. In order for an amplifier to maintain a constant output power for each channel when the number of channels changes, the gain of the amplifier must not vary with the total input signal power.

In response to adding and dropping of channels, the total signal power varies in a step function, with rapid, sometimes large changes. In order to maintain a constant gain and therefore a constant power for each remaining channel, the amplifier has to be working in an automatic gain control (AGC) regime, when the pump power to the amplifier is adjusted accordingly to variations of a ratio of an output power of the amplifier to its input power. Otherwise, with each dropped channel, the gain for the remaining channels and therefore their output power will increase.

Required level of optical gain for an amplifier depends on where the amplifier resides within a network, and within the same network the required level of optical gain can vary from one amplifier to another. To maintain a high signal to noise ratio and have low nonlinear penalties, the amplifier gain must precisely compensate for optical losses of the preceding fiber span and for optical losses of other networking elements co-located with the amplifier; both of them can vary in a wide range. If a co-located networking element has a particularly high loss, such as a dispersion compensating module (DCM) or an optical add/drop multiplexer (OADM), an amplifier for that node normally has a mid-stage access (MSA) for connecting such a networking element between two amplifying stages for minimizing its detrimental effect on the signal to noise ratio.

It is advantageous to have a single type of optical amplifier having an MSA an optical gain that can be adjusted in a wide range so it can be used in various network environments, rather than having to provide many different types of amplifiers. Since a direct control of gain by varying pump power leads to undesirable changes of a spectral shape of the optical gain, a variable optical attenuator (VOA) is often included between two amplifying stages to provide means for adjustments of the overall optical gain. An example of a prior-art double-stage optical amplifier with an MSA element co-located with a VOA is shown schematically in FIG. 2. However, the prior art solution shown in FIG. 2 is rather limited in achievable gain range, since its noise performance quickly deteriorates when the VOA loss becomes comparable to an optical gain of the first stage.

Noise performance of an amplifier is typically characterized by its noise figure (NF), which has to be minimized to achieve a low-noise operation. Noise figure of a single amplifying stage is defined as

$$NF ≡ \frac{{P}_{ASE}}{h v {B}_{o} G} + \frac{1}{G} , \qquad ( 1 )$$

where P_{ASE} is the amplified spontaneous emission noise power measured in an optical bandwidth of B₀ Hz, h≈6.626×10⁻34 JS is the Planck's constant, ν is the optical frequency of the signal in Hz, and G is the gain of the optical amplifier. For a dual-stage optical amplifier having a first-stage gain G₁, a second stage gain G₂, and co-located VOA and an MSA having optical loss L_{VOA} and L_{MSA} respectively, the total noise figure in linear units is given by

$$NF = {NF}_{1} + \frac{{L}_{VOA} - 1}{{G}_{1}} + \frac{{L}_{MSA} - 1}{{G}_{1} / {L}_{VOA}} + \frac{{NF}_{2} - 1}{{G}_{1} / ( {L}_{VOA} {L}_{MSA} )} \qquad ( 2 )$$

Where NF₁ and NF2 are noise figures of the first and second stages respectively, and gain and loss parameters are given in linear units At the low end of the gain range the VOA has to be set to a high level of attenuation, i.e. L_{VOA} is big, leading to a greatly decreased signal power at the entrance of the second stage, which degrades the NF and hence leads to a deterioration of the signal to noise ratio.

It is therefore desirable to provide a multi-stage amplifier having a programmable overall optical gain that can provide substantially stable gain over a plurality of channels being amplified, when other channels are added or dropped from the amplifying system, and which provides an optimum or near optimum noise performance for a wide range of gain settings.

It is an object of this invention to provide a multistage optical amplifier for operation in an AGC regime with a programmable overall optical again and a low noise figure within a wide gain range.

It is another object of this invention to provide a method for calibration of the programmable-gain multistage optical amplifier for providing a low pre-determined noise figure for the amplifier within a wide range of the overall optical gain.

### BRIEF DESCRIPTION OF THE DRAWINGS

Further features and advantages of the present invention will become apparent from the following detailed description, taken in combination with the appended drawings, in which:

FIG. 1 is a schematic diagram of a prior art optical communications link;

FIG. 2 is a schematic diagram of a prior-art dual-stage optical amplifier having a VOA co-located with an MSA module;

FIG. 3 is a diagram of a programmable-gain multi-stage optical amplifier for operation in an AGC mode having at least three amplifying stages.

FIG. 4 is a diagram of a single amplifying stage for operation in an AGC mode;

FIG. 5 is a diagram of a VOA module including attenuation control means;

FIG. 6 is a diagram illustrating automatic tracking of MSA loss with a co-located VOA.

FIG. 7 is a diagram illustrating automatic tracking of MSA loss with a non- co-located VOA.

FIG. 8 is a graph showing the noise figure versus the overall gain of an amplifier with a single VOA for varying position of the VOA.

FIG. 9 is a diagram of a multi-stage optical amplifier for having at least four amplifying stages.

FIG. 10 is a graph showing optimized noise figures for multi-stage amplifiers with varying number of VOAs.

FIG. 11 is a generalized flowchart of a method for selecting VOA loss values according to present invention.

FIG. 12 is a flowchart of a calibration process for selecting loss and gain values for the multi-stage optical amplifier.

FIG. 13 is a flowchart of a calibration process for selecting loss and gain values for the multi-stage optical amplifier with a nonlinear MSA module.

FIG. 14 is a diagram of a programmable controller having two calibration tables.

### SUMMARY OF THE INVENTION

The invention provides a programmable-gain multistage optical amplifier (PGMA) for amplifying an input WDM signal in a gain control regime, having an adjustable overall optical gain for amplifying the input WDM signal, the programmable-gain multistage optical amplifier comprising a plurality of amplifying stages at least some of which are optically coupled to subsequent amplifying stages through one or more variable optical attenuators, and control means for controlling attenuation values of the variable optical attenuators, wherein said one or more variable optical attenuators have a programmable set of attenuation values for providing a programmable overall optical gain and a substantially fixed pre-determined low noise figure for the multistage optical amplifier, and wherein in operation, the overall optical gain of the multistage optical amplifier is kept essentially constant.

Another aspect of the invention provides a method of selecting attenuation values for the variable optical attenuators and gain values for the amplifying stages for the programmable-gain multistage optical amplifier having at least three amplifying stages and at least two variable optical attenuators, for providing said multistage optical amplifier with a pre-determined amount of overall optical gain G and the substantially fixed low noise figure. The method comprise steps of: a) determining a total attenuation value L dB for all variable attenuators required for providing the overall optical gain G, b) determining a minimum attenuation value L₁ₘᵢₙ₁ of the first variable optical attenuator required to maintain the pump powers of the pump lasers of the subsequent amplifying stages within their stable operating ranges, c) selecting a maximum attenuation value Lₘₐₓ not exceeding Lₘₐₓ₂ for the second variable optical attenuator and an attenuation value Lₘᵢₙ=L/Lₘₐₓ for the first variable optical attenuator, wherein Lₘᵢₙ exceeds L₁ₘᵢₙ₁.

### DETAILED DESCRIPTION OF THE PREFERRED EMBODIMENT

In a first aspect of the invention, a programmable-gain multi-stage optical amplifier for operation in an automatic gain control (AGC) regime is provided, the programmable-gain multi-stage optical amplifier comprising a mid-stage access (MSA) for connecting a networking element hereafter referred to as an MSA module, and a one or more variable optical attenuators (VOA), wherein the MSA and at least one of the VOAs are located in different stages of the amplifier for providing a substantially low constant noise figure in a wide range of the programmable overall gain of said amplifier.

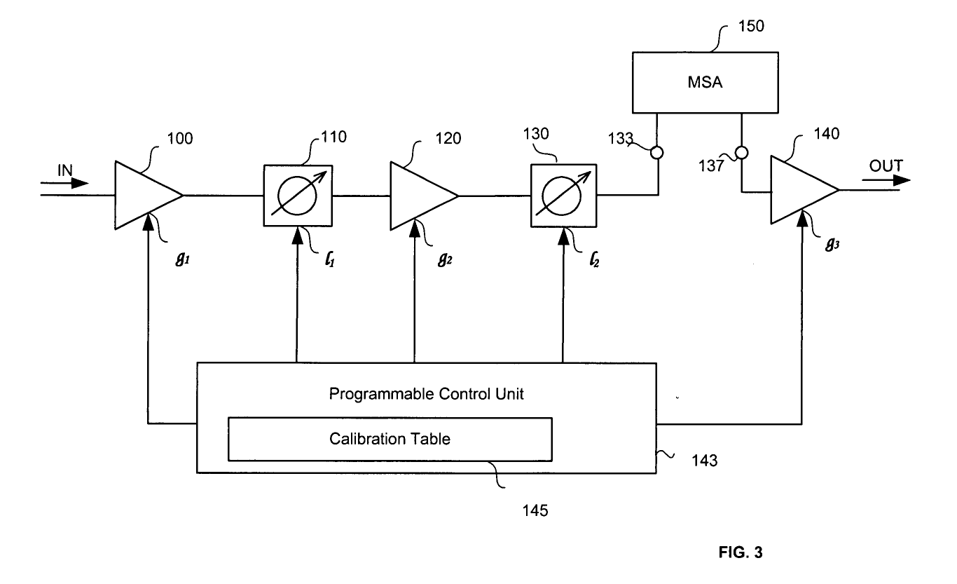

A preferred embodiment of the programmable-gain multistage optical amplifier is shown in FIG. 3 and is hereafter described.

The amplifier comprises three amplifying stages 100, 120 and 140, two VOA modules 110 and 130, and an MSA module 150. Each amplifying stage and each VOA module has an input optical port, an output optical port, and a communication port. The amplifying stages 100, 120 and 140 are capable of providing adjustable optical gains for amplifying WDM signals entering through their respective input optical ports. The VOA modules 110 and 130 provide adjustable optical loss, or adjustable attenuation, for optical signals entering their input optical ports which values are selectable through their respective communication ports l₁ and l₂ and can vary between a minimum attenuation value L₁ₘᵢₙ and a maximum attenuation value L₁ₘₐₓ for the VOA module 110, and between a minimum attenuation value L₂ₘᵢₙ and a maximum attenuation value L₂ₘₐₓ for the VOA module 130. The optical output port of the first amplifying stage 100 is connected to an optical input port of the first VOA module 110. The output optical port of the VOA module 110 is connected to the input optical port of the second amplifying stage 120, and the output optical port of the second amplifying stage 120 is connected to an input optical port of the second VOA module 130. The output optical port of the second VOA module is connected to an input MSA port 133 for connecting an input port of the MSA module 150. An output MSA port 137 for connecting an output port of the MSA module 150 is connected to an input port of the third amplifying stage 140. The input optical port of the amplifying stage 100 and the output optical port of the amplifying stage 140 respectively serve as an input and output optical ports of the entire multistage amplifier.

The MSA module can comprise for example a dispersion compensating fiber (DCF) for compensating chromatic dispersion of a portion of the transmission link, or an optical add-drop module (OADM), and can have a significant optical loss L_{MSA}. The programmable-gain multistage optical amplifier may also be used at a network location having no networking function requiring a functional MSA module. In that case, the MSA module can be replaced with a connectorized piece of optical fiber for providing optical connectivity between the MSA ports 133 and 137 having a minimal optical loss and therefore a negligible effect on operation of the PGMA. For the purpose of present invention, such an amplifier can be considered as having an MSA module with L_{MSA}=1. Note that linear units for loss, gain and noise figure are herein assumed, so that an ideal passive optical element which does not change optical power of a signal and does not add any noise would have a unity loss, a unity gain and a unity noise figure.

A programmable control unit 143 is further provided comprising a calibration table 145 for storing calibration data as described hereafter. The programmable control unit 143 uses the calibration data stored in the calibration table 145 for generating gain values G₁,G₂ and G₃ of the amplifying stages, and attenuation values L₁, L₂ of the VOA modules, required for providing a desired overall optical gain G. The generated gain and loss values are communicated to the respective amplifying stages and VOA modules through their communication ports labeled g₁, g₂, g₃, and l₁ and l₂ to achieve the desired value of the overall optical gain G.

The amplifying stages 100, 120 and 140 have internal control means for operating in an AGC regime wherein their optical gains are maintained substantially constant and approximately equal to the values communicated through the communication ports g₁, g₂, g₃ respectively.

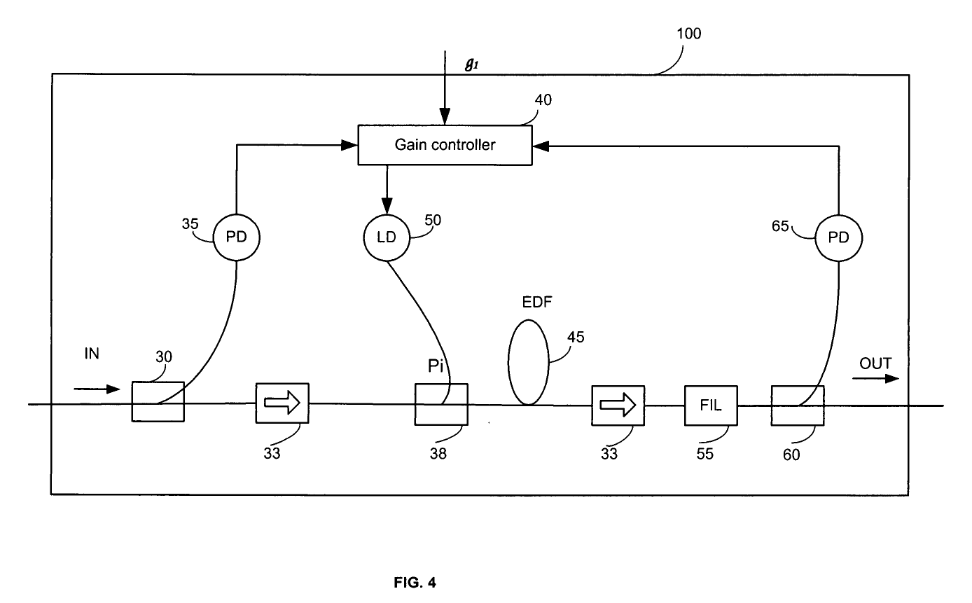

With reference to FIG. 4, the amplifying stage 100 comprises a piece of erbium-doped fiber (EDF) 45, a one or more pump lasers 50 for providing pump power for the EDF 45 whereby providing an optical gain for a WDM signal propagating through the EDF, a WDM coupler 38 for coupling the pump power into the EDF 45, and gain control means for controlling the optical gain between an input port and an output port of the amplifying unit 100. The gain control means includes a gain controller 40, an input photodetector 35, and an output photodetector 65. The gain controller 40 have two electrical input ports for receiving electrical signals from the photodetectors 35 and 65, a one or more electrical outputs for controlling drive currents of the one or more pump lasers 50, and a communication port g₁ for receiving a target value of optical gain G₁ from the programmable control unit 143.

In operation the gain controller maintains the optical gain of the amplification stage 100 substantially equal to the value G₁ received from the programmable control unit 143 by adjusting the drive current of the pump laser 50 and thereby the pump power P₁ in response to the electrical signal from the photodiodes 35 and 65. The pump laser 50 is capable of providing pump power P₁ between a minimum value P₁ₘᵢₙ and a maximum value P₁ₘₐₓ, which define a range of stable operation of the pump laser.

Internal design of the amplifying stages 120 and 140 can be essentially identical to the aforedescribed design of the amplifying stage 100.

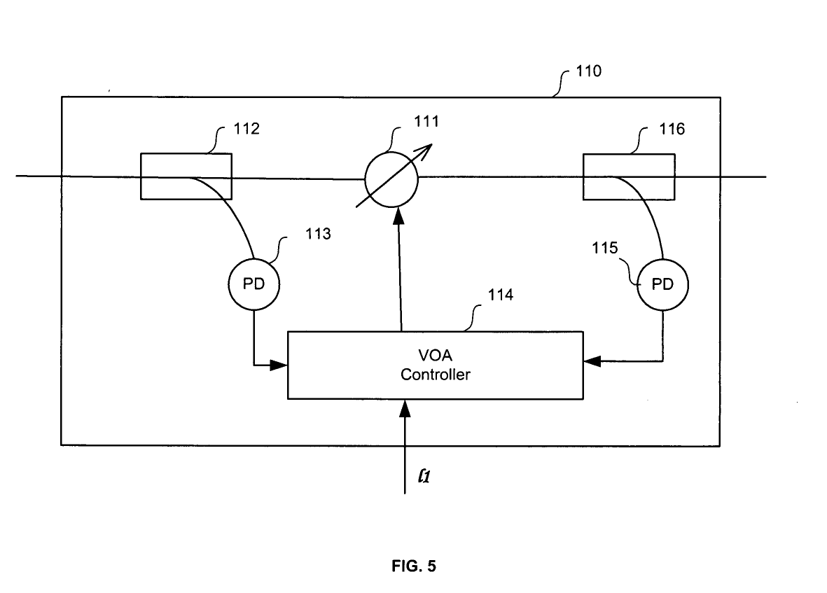

Similarly, all VOA modules can have an essentially identical design which is shown in FIG. 5 with reference to VOA module 110 as an example. The VOA module 110 has an input port and an output port, a variable optical attenuator 111 for providing an adjustable optical attenuation between the input and output ports, a communication port l₁ for receiving a target optical attenuation value L₁, and control means for maintaining the optical attenuation of the VOA block at a substantially constant level substantially equal to L₁. The VOA control means includes optical couplers 112 and 116, photodetectors 113 and 115 for monitoring power levels of the propagating optical signal before and after the VOA, and a VOA controller 114. Information from the photodetectors 113 and 115 is used by the VOA controller 116 to determine an actual optical loss of the VOA to enable compensation for possible variations of the VOA loss properties with time.

The overall optical gain G of the PGMA is determined by an equation

G=G₁×G₂×G₃× . . . ×1×/L₁×1/L₂× . . . ×1/L_{MSA} (3)

Since in operation optical gains of the amplifying stages and optical losses of the VOA modules are automatically controlled at the substantially constant levels as described thereabove, the overall optical gain G remains substantially constant as well, provided that the optical loss of the MSA remains substantially unchanged. Therefore, the aforedescribed PGMA operates in an automatic gain control mode, thereby preventing large fluctuations of channel power when optical channels are added or dropped.

Some MSA modules, for example those comprising certain types of DCF, can in operation experience considerable variations of their optical loss due to for example changing environmental conditions. Therefore in other embodiments of the first aspect of the invention an automatic tracking and compensation of the MSA loss variations can be implemented, for example by appropriately varying attenuation of one of the VOA modules, hereafter referred to as a tracking VOA. Two possible embodiments for automatic tracking and compensation of the time-variable MSA loss will now be briefly described.

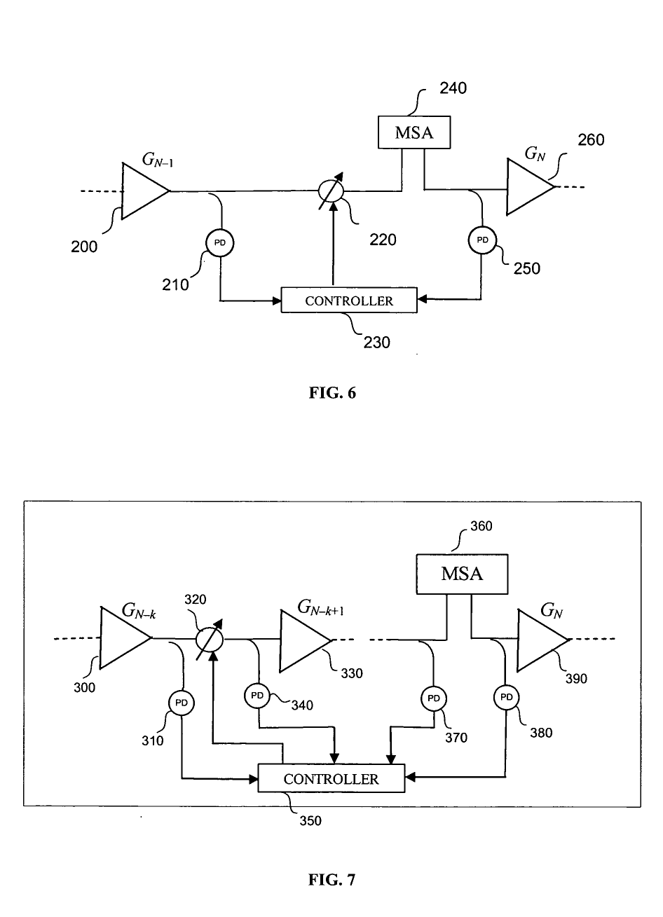

With reference to FIG. 6, the tracking VOA 220 is co-located with the MSA module 240 between consecutive amplifying stages 200 and 260. Monitoring means 210 and 250 such as photodetectors are provided for monitoring optical power levels before and after propagation through the tracking VOA 220 and the MSA module 240. A controller is provided having two electrical inputs connected to electrical outputs of the monitoring means 210 and 250, and an electrical output for controlling attenuation value of the tracking VOA 220. The controller 230 determines a total optical loss L′ between the input port of the tracking VOA and the output port of the MSA, and controls the attenuation level of VOA 220 to keep L′ at a substantially constant level.

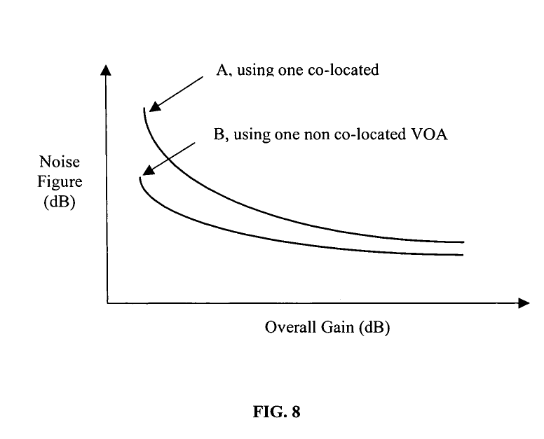

With reference to the embodiment shown in FIG. 7, the tracking VOA 320 and the MSA module have at least one amplifying stage 330 between them. This configuration can provide a lower noise figure for the PGMA as hereafter described. However this embodiment requires separate monitoring of optical loss of the tracking VOA and of optical loss of the MSA module, and therefore comprises four monitoring photodetectors 310, 340, 370, and 380. The controller 350 determines optical loss of the MSA module 360 using information received from the monitoring photodiodes 370 and 380, and controls the attenuation level of VOA 320 to keep the total loss of the tracking VOA 320 and the MSA module at a substantially constant level.

The PGMA can be programmed to have different overall optical gain G in a certain gain range from a minimum amplifier gain Gₘᵢₙ to a maximum amplifier gain Gₘₐₓ. The gain range is limited by the pump power availability at a high-gain side of the range, and by a rise of the noise figure on the low-gain side of the gain range of the amplifier due to increasing VOA loss. The present invention enables widening of the gain range of the amplifier by reducing its noise figure, especially in the low-gain region, thereby extending the gain range to considerably lower gain values. This is achieved firstly by employing VOA modules positioned between different amplifying stages than the MSA module thereby spreading the loss between multiple amplifier stages, and secondly by an optimum selection of the gain and loss distribution along the amplifier as hereafter described.

With reference to FIG. 8, a curve “A” schematically shows the noise figure versus the overall optical gain for a conventional dual-stage amplifier shown in FIG. 2 having a VOA co-located with the MSA. A curve “B” schematically shows a considerably improved noise figure achieved by employing a single non co-located VOA in a multi-stage amplifier, which corresponds to a non-optimal loss configuration of the PMGA shown in FIG. 3, wherein the second VOA module 130 has no loss. A considerable “flattening” of the curve “B” towards lower values of the overall gain is evident, demonstrating a lesser dependence of the noise figure on the VOA loss and the overall optical gain of the amplifier.

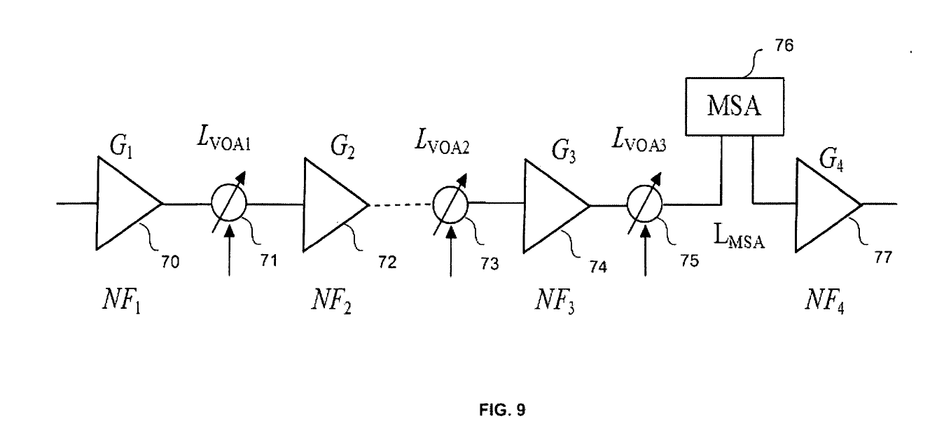

Note that although the aforedescribed embodiment of the first aspect of the invention provides a three-stage amplifier with two VOA modules between consecutive amplifying stages, the invention is not limited to a three-stage amplifier. Other embodiments may comprise additional amplifying stages and additional VOA modules enabling further distribution of the optical loss between gain stages, as for example for a multistage amplifier shown in FIG. 9, which has four or more amplifying stages and three non co-located VOAs between the amplifying stages. This four-stage amplifier is capable of providing a lower noise figure compared to the three-stage amplifier with two VOA modules, provided that the loss and gain are optimally distributes between its stages.

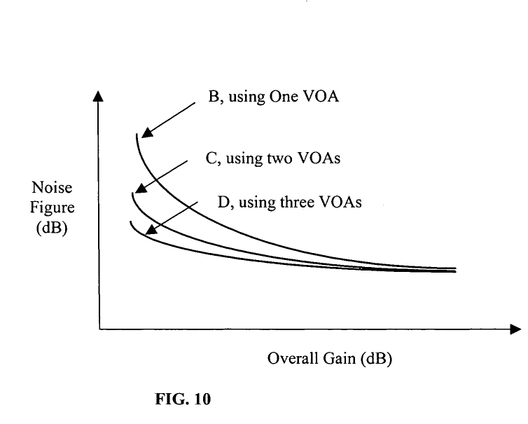

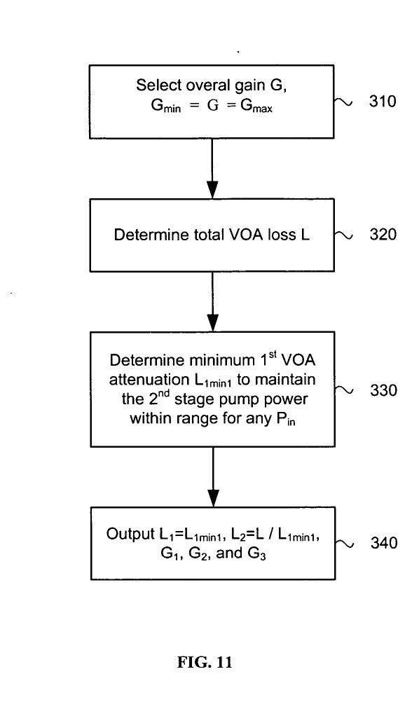

With reference to FIG. 10, curves “B”, “C” and “D” schematically show best achievable noise figures for multi-stage amplifiers having a one, two and three non co-located VOA modules, corresponding to amplifiers shown in FIG. 2, 3 and 10 respectively. The curve labeled “D” showing noise figure of the multistage amplifier with three VOA modules illustrates that a further noise figure improvement is achievable when a number of non co-located VOA modules is increased, albeit the “efficiency” of adding new stages with additional VOA modules in terms of a noise figure improvement decreases with each additional VOA module.

The noise figure improvements illustrated by curves “B” and “C” can be obtained when the distribution of gain values between the amplifying stages and loss values between the VOA modules is optimized. This optimization is however a nontrivial task.

Noise figure NF of the three-stage amplifier in accordance with the preferred embodiment can be calculated using an equation (4)

$$NF = {NF}_{1} + \frac{{L}_{1} - 1}{{G}_{1}} + \frac{{NF}_{2} - 1}{{G}_{1} / {L}_{1}} + \frac{{L}_{2} {L}_{MSA} - 1}{{G}_{1} {G}_{2} / {L}_{1}} + \frac{{NF}_{3} - 1}{{G}_{1} {G}_{2} / ( {L}_{1} {L}_{2} {L}_{MSA} )} \qquad ( 4 )$$

wherein NF₁, NF₂ and NF₃ are noise figures of the first, second and third amplifying stages respectively, and L_{MSA} is optical loss of the MSA module, all parameters in linear units. Equation (4) can be easily extrapolated for an amplifier having more than 3 amplifying stages. According to equation (4), to reduce the noise figure NF one has to increase gain of the amplifying stages closest to the amplifier's optical input, and reduce loss of the VOAs closest to the optical input. However, finding optimum values for the optical gain of the amplifying stages and for the optical loss of the VOAs minimizing NF for each possible overall gain value is complicated by restrictions, such as those imposed upon the gain and loss distributions by the pump power availability, the need to maintain the drive current of the pump lasers within their stable operation range when the input signal power is varying, and by the MSA input power limitations.

A solution to the aforedescribed optimization problem is given in a second aspect of the present invention, which provides a method for selecting the VOA attenuation values and the optical gains of the amplifying stages for any value of the overall optical gain within a wide gain range. This method can be used during calibration of the amplifier for generation of sets of optimized gain and loss values which can be stored in the calibration table 145 of the programmable controller of the PGMA, whereby enabling an easy programming of the PGMA for any pre-determined value of the overall optical gain.

The method of selecting gain values for the amplifying stages and attenuation values for the VOA modules of the PGMA according to present invention for achieving a substantially fixed low noise figure for any pre-determined overall optical gain G in a wide gain range, will now be described.

The method is provided with a following set of input parameters: (a) an allowable range of the input power Pᵢₙ between a minimum input signal power Pᵢₙ_{_{—}}ₘᵢₙ and a maximum input signal power P_{in max} which may depend on the overall gain value G, (b) the minimum and maximum values of the pump powers P_{i min} and P_{i max}, i=1, 2 or 3, for all amplifying stages that define stable operating ranges of the pump lasers, and (c) the supported maximum and minimum values of the overall optical gain of the amplifier Gₘₐₓ and Gₘᵢₙ.

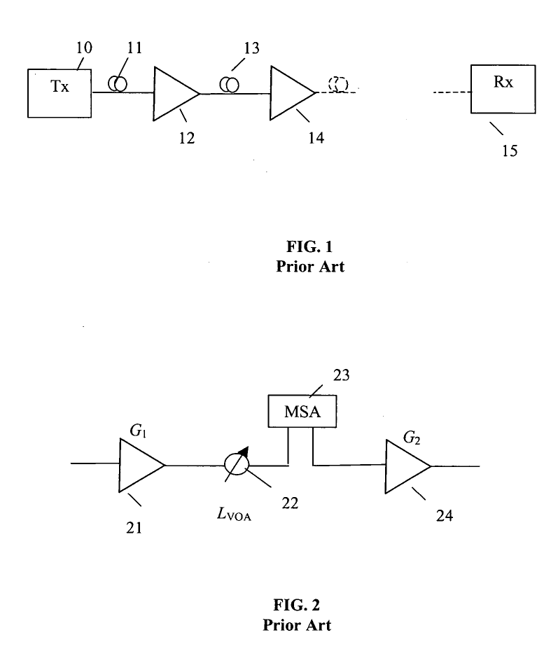

With reference to FIG. 1, in a first step 310 a value of the overall optical gain G between Gₘᵢₙ and Gₘₐₓ is selected, Gₘᵢₙ≦G≦Gₘₐₓ.

In a second step 320 the total optical loss L=L₁×L₂ of the two VOA modules is computed as

L=Gₘₐₓ/G

Note that this choice of total optical loss of the VOAs requires that a combined optical gain G_{□}of the three amplifying stages, defined as G_{□}=G₁×G₂×G₃, is fixed and is equal to Gₘₐₓ for all values of the overall amplifier gain within its design range. Note also that the minimum values L₁ₘᵢₙ and L₂ₘᵢₙ of VOA attenuations are herein assumed to include constant insertion loss of the VOA modules and insertion loss of all optical elements other than VOAs between the respective amplifying stages; for example, L₂ₘᵢₙ may include MSA loss L_{MSA}.

In a third step 330, a minimum attenuation value L₁ₘᵢₙ₁ for the first VOA module is determined required to maintain the pump power for the second and third amplifying stages within it stable operating range for any value Pin of the input power to the amplifier within the allowable range of the input signal power.

In a preferred embodiment of the third step 330, optical gain values G₁, G₂ and G3 for each amplifying stage are also defined as hereafter explained.

In a forth step 340, the attenuation values for the VOA modules are finally determined in accordance with L₁=L₁ₘᵢₙ₁, L₂=L/L₁ₘᵢₙ₁; the determined attenuation values L₁ and L₂, and the gain values G₁, G₂ and G₃ are stored into the calibration table.

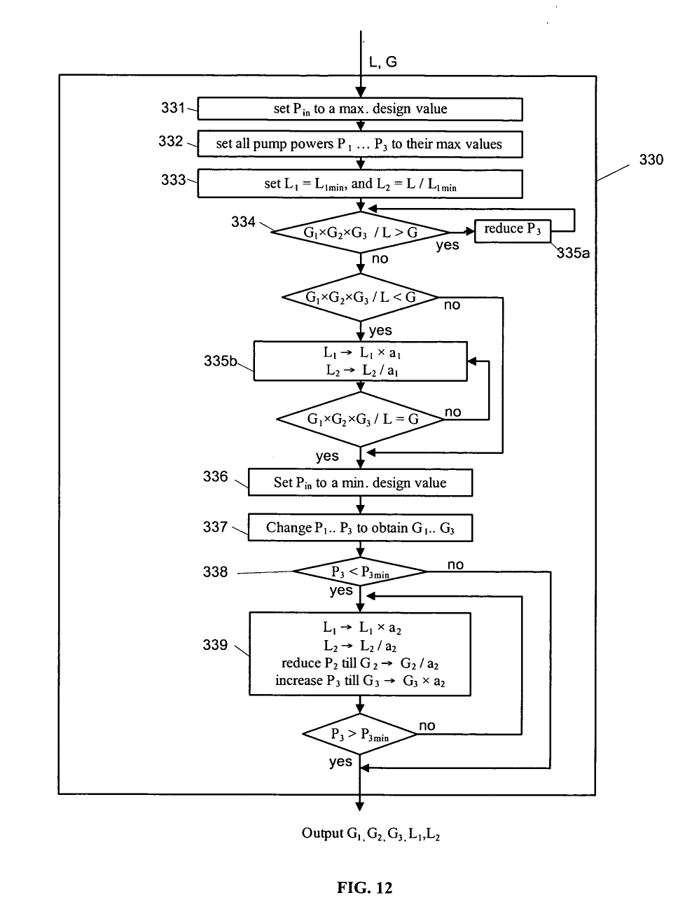

FIG. 12 shows a flowchart of a calibration process implementing the third step 330 in accordance with a preferred embodiment of this aspect of the invention; other implementations of this step are possible within the scope of present invention. This process can be for example implemented as a part of a general calibration procedure at a manufacturing stage.

In a first step 331, input signal power Pin from a multi-channel optical source is set to the maximum design value P_{in max}. This will require highest pump powers for the amplifying stages to provide a certain gain, thereby enabling identifying safe gain and loss settings wherein maximum pump powers are not exceeded.

In a second step 332, all drive currents of the pump lasers in all amplifying stages are set to their maximum values within their respective safe operating ranges, thereby providing maximum pump powers Pᵢ=P_{i max}.

In a third step 333, attenuation of the first VOA is set to its minimum value L₁ =L₁ₘᵢₙ, and attenuation of the second VOA is set to L₂=L/L₁ₘᵢₙ.

In a forth step 334, resulting optical gains G1, G₂ and G3 of the first, second and third amplifying stages are determined, and their combined gain G_{Σ} is compared with Gₘₐₓ. If it is found that G_{Σ}>Gₘₐₓ, then in a next step 335a the pump power of the third amplifying stage is reduced until G_{Σ} becomes substantially equal to its target value Gₘₐₓ. If alternatively it is determined that G_{Σ}<Gₘₐₓ, another step 335b is implemented instead of the step 335a, wherein the attenuation of the first VOA is being step-wise increased by a small amount in a time and the attenuation value of the second VOA is being decreased by the same amount so to maintain the total VOA loss equal to L, until G_{Σ} becomes substantially equal to its target value Gₘₐₓ.

Note that a procedure of step 335b converges since the third gain stage typically operates in a less saturated regime than the second stage, and therefore the gain of the third stage is more sensitive to changes in its input optical power.

In a next stage 336, optical power Pᵢₙ of the input optical signal is set to the minimum design value P_{in min}. This will require lowest pump powers, thereby enabling identifying safe gain and loss settings wherein the drive currents of the laser pumps exceed their respective minimum values required for stable operation.

In a next step 337, pump powers of the amplifying stages are changed, typically reduced, so to maintain same optical gains G₁, G₂ and G3 as obtained in the step 335a or step 335b.

In a next step 338 the pump power P₃ of the third amplifying stage is compared with its minimum limit P_{3 min}; if P₃>P_{3 min}, the calibration process for gain and loss values is complete, and current gain values G₁, G₂, G3 and VOA attenuation values L₁ and L₂ form an output of the calibration process. Otherwise if in the step 338 it is found that P₃<P_{3 min}, the calibration process continues with a next step 339, wherein:

a) L₁ is slightly increased by a factor a₂>1,

b) L₂ is decreased by a factor a₂,

c) G₂ is decreases by a factor a₂ by appropriately decreasing the pump power P₂,

d) G3 is increased by a factor a₂ by appropriately increasing the pump power P₃.

A collective effect of the steps (a)-(d) will be to increase an input power into the third amplifying stage by Δ₂ dB, thereby increasing the pump power P₃. The steps (a)-(d) are repeated until P₃>P₃ₘᵢₙ, whereupon the calibration process for gain and loss values is complete; final gain values G₁, G₂, G₃ and loss values L₁, L₂ are registered and form an output of the calibration process.

The calibration table for the programmable-gain multistage amplifier can be created by repeating the aforedescribed calibration method for a plurality of values of the overall optical gain G, wherein said plurality would typically include at least Gₘᵢₙ and Gₘₐₓ, and recording the found sets of values G₁, G₂ G₃ L₁ L₂ for each G. If the overall optical gain of the PGMA has to be set on a finer grid than that stored in the calibration table, the programmable calibration unit can determine the required but missing gain and loss values for the amplifying stages and the VOA modules by interpolation.

Note that the aforedescribed calibration procedure can be generalized for a multistage amplifier having more than three amplifying stages and more than 2 VOA modules.

Note also that the aforedescribed calibration procedure is equally applicable to a multistage amplifier with and without an MSA module, provided that the MSA module does not impose additional power limitations. During the calibration procedure a fixed attenuator can then be used in place of the MSA module, its optical loss can be accounted for by adding it to the minimum loss of the co-located VOA module, L₂min. The calibration table obtained with the aforedescribed calibration procedure can therefore include sets of gain values G_{1,2,3} for the amplifying stages and loss values L₁,₂ for the VOA modules for different combinations of the overall optical gain and MSA loss.

If the MSA modules includes an optical unit having nonlinear optical properties such as DCF and therefore having a maximum allowable input optical power per channel P_{MSA}^{max}, care may have to be taken to ensure that an actual optical power per channel at the input MSA port P_{MSA} does not increased P_{MSA} max for any allowable G or Pᵢₙ.

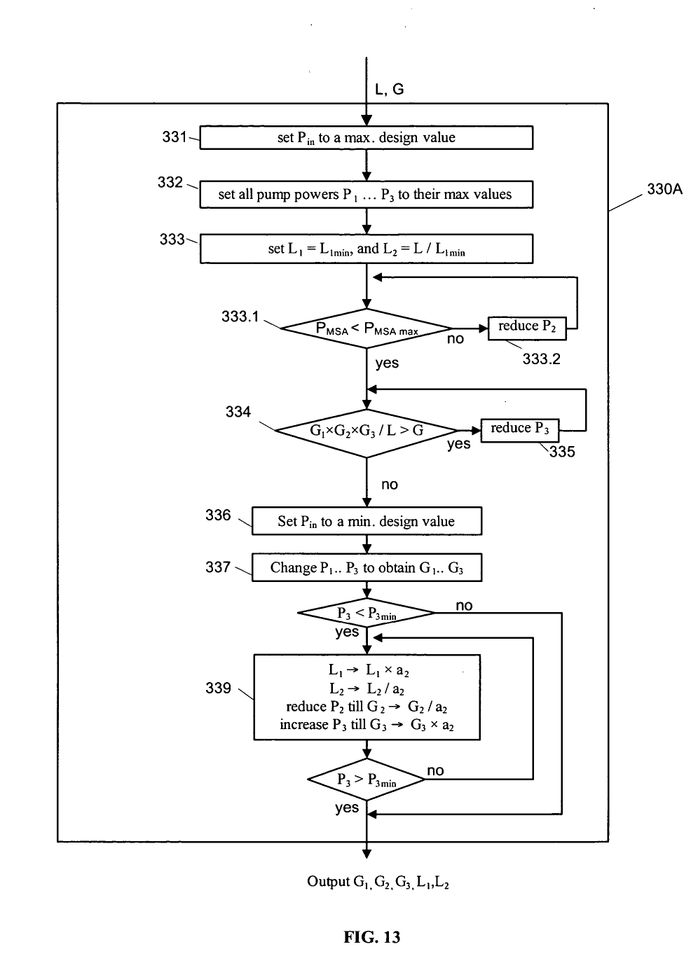

FIG. 13 shows an alternative calibration procedure 330A for selecting gain values G₁, G₂, and G₃ and attenuation values L₁ and L₂, which has to be used instead of the calibration procedure 330 for the multistage amplifier with an MSA module having a maximum allowable input optical power per channel P_{MSA}^{max}. This procedure retains most of the steps of the procedure 330 shown in FIG. 12, with the following exceptions:

a) a multichannel optical source is used during the calibration to enable monitoring of the optical power per channel;

b) a fixed optical attenuator is connected between the MSA ports with optical loss equal to a maximum optical loss of the MSA, and the optical loss L₂ includes the loss of the fixed attenuator and is defined as an optical loss between the output MSA port 137 and the output port of the second amplifying stage 120;

c) maximum optical power per channel is monitored at the input optical port of the MSA;

d) a new step 3331 is introduced following the step 333, wherein the optical power per channel at the MSA input port P_{MSA} is compared with the allowed maximum power per channel P_{MSA}^{max}. If it is found that P_{MSA}>P_{MSA}^{max} the pump power P₂ in the second amplifying stage is reduced;

e) the step 335b is eliminated, since decreasing the attenuation of the second VOA would lead to an increase in the optical power at the MSA input port. Instead, in the considered case wherein the input power per channel into the MSA is limited, the condition G_{Σ}≧Gₘₐₓ/L at this calibration step has to be guaranteed by an appropriate design of the amplifying stages, for example by providing sufficient pump power.

This calibration procedure 330A shown in FIG. 13 effectively imposes an additional limitation on the optical gain G₂ of the amplifying stage immediately preceding the MSA module, and therefore may result in sub-optimal noise performance when applied to the PGMA not having a power-sensitive MSA modules.

It may not be known however at a calibration time if the programmable-gain multistage optical amplifier is going to include a power-sensitive MSA module when the amplifier is installed in a network.

Therefore in another embodiment of the first aspect of the invention, the programmable control unit 143 of the programmable-gain multistage optical amplifier is capable of selecting between two sets of gain and loss values individually optimized for two different modes of operation.

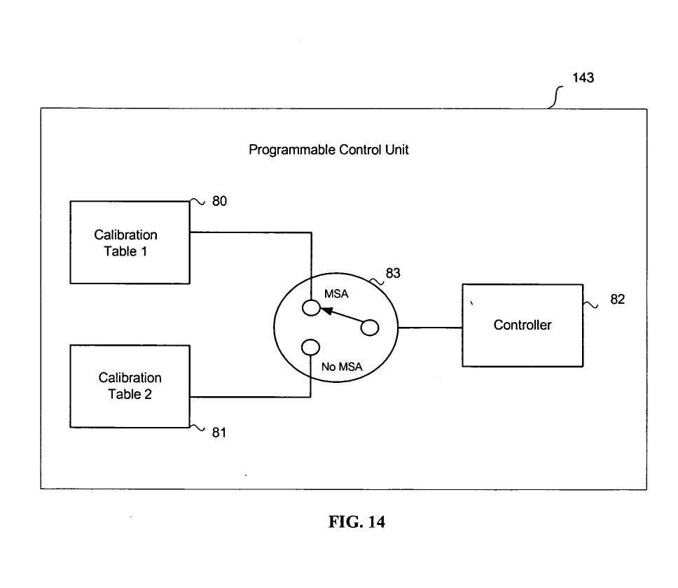

With reference to FIG. 14, the programmable controller of this embodiment comprises a first calibration table 80 having a first set of calibration data defining optical loss and gain values G_{1,2,3} and L_{1,2} for one or more values of the overall optical gain, a second calibration table 81 having a second set of calibration data defining optical loss and gain values G_{1,2,3} and L₁,₂ for one or more values of the overall optical gain, a switch 83 for selecting between the first and the second calibration tables, and a controller 82 for controlling the switch 83.

The first set of calibration data can for example be determined using the aforedescribed calibration process 330 which provides gain and loss setting optimized without the MSA power limitations and therefore providing lower noise figure. The second set of calibration data can for example be determined using the calibration process 330A which provides gain and loss setting optimized accounting for MSA power limitations and therefore providing a relatively higher noise figure, but satisfying the MSA power requirements.

The programmable control unit communicates the loss and gain data from the first or the second calibration table as selected by the switching unit 83 to the gain and loss controllers upon selection of an overall gain value. In some embodiments, the control unit may be capable of an automatic selection of a correct calibration table as defined by the amplifier configuration and/or by an external shelf controller.

Numerous other embodiments may be envisaged without departing from the spirit and scope of the invention.

1. A programmable-gain multistage optical amplifier for amplifying an input WDM signal in a gain control regime, having an adjustable overall optical gain for amplifying the input WDM signal, the programmable-gain multistage optical amplifier comprising:
i) a plurality of amplifying stages at least one of which is optically coupled to subsequent amplifying stages through one or more variable optical attenuators;
ii) control means for controlling attenuation of the variable optical attenuators and for controlling of optical gain of the amplifying stages;
wherein the programmable-gain multistage optical amplifier is programmed with a set of attenuation values, wherein in operation the variable optical attenuators are responsive to the set of attenuation values for providing a programmable overall optical gain and a substantially fixed pre-determined low noise figure for the multistage optical amplifier,
and wherein in operation, the overall optical gain of the multistage optical amplifier is kept essentially constant.

2. A multistage optical amplifier as defined in claim 1, further comprising a plurality of control means for controlling an optical gain of each of the amplifying stages at a pre-determined substantially constant level.

3. A multistage optical amplifier as defined in claim 2, having at least a first amplifying stage for receiving a WDM signal and for outputting a first amplified WDM signal, a second amplifying stage for receiving an attenuated portion of the first amplified WDM signal and for outputting a second amplified WDM signal, a third amplifying stage for receiving an attenuated portion of the second amplified WDM signal and outputting a third amplified WDM signal, a first variable optical attenuator having a minimum attenuation value L₁ₘᵢₙ dB, and a maximum attenuation value L₁ₘₐₓ dB optically coupling the first amplifying stage and the second amplifying stage for attenuating the first amplified WDM signal by a first attenuation value, and a second variable optical attenuator having a minimum attenuation value L₂ₘᵢₙ and a maximum attenuation value L₂ₘₐₓ optically coupling the second amplifying stage and the third amplifying stage for attenuating the second amplified WDM signal by a second attenuation value,
wherein each of the amplifier stages includes a gain medium and a plurality of pump lasers optically coupled to the gain medium for providing a predetermined amount of optical gain,
and wherein each of the pump lasers has a minimum drive current and a maximum drive current, and a stable operating range therebetween.

4. A method of selecting attenuation values for the variable optical attenuators for a multistage optical amplifier as defined in claim 3, for providing said multistage optical amplifier with a pre-determined amount of overall optical gain G and the substantially fixed low noise figure, the method comprising steps of:
a) determining a total attenuation value L dB for the first and second variable attenuators required for providing the overall optical gain G,
b) determining a minimum attenuation value L₁ₘᵢₙ₁ of the first variable optical attenuator required to maintain the drive currents of the pump lasers of the second amplifying stage within their stable operating ranges,
c) selecting a maximum attenuation value Lₘₐₓ not exceeding Lₘₐₓ₂ for the second variable optical attenuator and an attenuation value Lₘᵢₙ=L/Lₘₐₓ for the first variable optical attenuator, wherein Lₘᵢₙ exceeds both L₁ₘᵢₙ, and L₁ₘᵢₙ₁.

5. A multistage optical amplifier in accordance with claim 3, comprising a programmable control unit.

6. A multistage optical amplifier in accordance with claim 5, wherein the programmable control unit is programmed with attenuation values for the variable optical attenuators for a plurality of overall optical gain values.

7. A multistage optical amplifier in accordance with claim 6, wherein the attenuation values for the variable optical attenuators for a plurality of overall optical gain values is obtained using the method of claim 4.

8. A multistage optical amplifier in accordance with claim 1, further comprising an optical networking unit positioned to receive at least a partially amplified input WDM signal.

9. A multistage optical amplifier in accordance with claim 8, wherein in operation said optical networking unit has a maximum input optical power.

10. A multistage optical amplifier in accordance with claim 9, wherein said optical networking unit is a dispersion compensation module for providing pre-determined amounts of chromatic dispersion compensation.

11. A plurality of multistage optical amplifiers in accordance with claim 8, wherein said optical networking unit is an optical add/drop module for adding or dropping optical channels or groups of optical channels.

12. A multistage optical amplifiers in accordance with claim 8, further comprising monitoring means for monitoring optical loss of the optical networking unit, and wherein in operation total optical loss of said variable optical attenuator and said optical networking unit is kept substantially constant.

13. A multistage optical amplifier in accordance with claim 12, further comprising monitoring means for monitoring optical loss of at least one of the variable optical attenuators.

14. A multistage optical amplifier comprising dispersion compensation modules in accordance with claim 13, further comprising at least one amplifying stage between said dispersion compensating modules and said variable optical attenuators.

15. A method of selecting attenuation values of the variable optical attenuators for a multistage optical amplifier according to claim 3, wherein said multistage optical amplifier further comprises an optical networking unit disposed to receive a WDM signal attenuated by the first variable optical attenuator and the second variable optical attenuator and amplified at least by the first amplifying stage and the second amplifying stage, for providing said multistage optical amplifier with a pre-determined amount of overall optical gain G and the pre-determined low noise figure, the method comprising steps of
a) determining a total attenuation value L for the first and second variable attenuators combined required for providing the overall optical gain G,
b) determining a minimum attenuation value L₁ₘᵢₙ₁ of the first variable optical attenuator required in operation for keeping the drive currents of the pump lasers of the second amplifying stage within their stable operating ranges,
c) selecting a maximum attenuation value Lₘₐₓ not exceeding Lₘₐₓ₂ for the second variable optical attenuator and an attenuation value Lₘᵢₙ=L/Lₘₐₓ for the first variable optical attenuator, wherein Lₘᵢₙ exceeds both L₁ₘᵢₙ, and L₁ₘᵢₙ₁, and wherein in operation optical power received by the optical networking unit does not exceed a fixed pre-determined value.

16. A multistage optical amplifier in accordance with claim 8, comprising a programmable control unit.

17. A multistage optical amplifier in accordance with claim 16, wherein the programmable control unit is programmed with attenuation values for the variable optical attenuators for a plurality of overall optical gain values.

18. A multistage optical amplifier in accordance with claim 16, wherein the programmable control unit is programmed with attenuation values for the variable optical attenuators for a plurality of overall optical gain values and a plurality of loss values for the optical networking unit.

19. A multistage optical amplifier in accordance with claim 18, wherein said attenuation values for the variable optical attenuators for the plurality of overall optical gain values was obtained using the method of claim 15.

20. A multistage optical amplifier in accordance with claim 16, wherein the programmable control unit is programmed with a first set of attenuation values for the variable optical attenuators for a plurality of overall optical gain values and a second set of attenuation values for the variable optical attenuators for said plurality of overall optical gain values,
wherein said first set of attenuation values is obtained using the method steps defined in claim 4, and said second set of attenuation values was obtained using the method steps defined in claim 15.

21. A plurality of multistage optical amplifiers for operating in a gain control regime, each having
i) an optical input for receiving an input WDM signal and an optical output for outputting an amplified WDM signal,
ii) an adjustable overall optical gain for amplifying the WDM signal,
iii) a plurality of amplifying stages at least some of which are optically coupled to subsequent amplifying stages through one or more variable optical attenuators,
iv) a control means for controlling attenuation values of the variable optical attenuators,
wherein said one or more variable optical attenuators have a first set of attenuation values for providing a pre-determined overall optical gain and a substantially fixed low noise figure for the multistage optical amplifier,
and wherein in operation, the overall optical gain of each multistage optical amplifier is kept essentially constant, and wherein some of the plurality of the multistage optical amplifiers are programmed with different attenuation values to provide different fixed overall gain and a substantially same noise figure.
